(19) United States
(12) Patent Application Publication
(10) Pub. No.: US 2014/0081970 A1
(43) Pub. Date: Mar. 20, 2014

(54) INFORMATION PROCESSING APPARATUS, SERVER, INFORMATION PROCESSING SYSTEM AND INFORMATION PROCESSING METHOD

(71) Applicant: Masahiro Sueyoshi, Kanagawa (JP)

(72) Inventor: Masahiro Sueyoshi, Kanagawa (JP)

(73) Assignee: SONY CORPORATION, Tokyo (JP)

(21) Appl. No.: 13/992,906

(22) PCT Filed: Oct. 1, 2012
(86) PCT No.: PCT/JP2012/006271

§ 371 Date: Jun. 10, 2013

(30) Foreign Application Priority Data
Oct. 18, 2011 (JP) 2011-228452

(51) Int. Cl. G06F 17/30

(52) U.S. Cl. CPC G06F 17/30864
USPC 707/736

(57) ABSTRACT

There is provided a server that may include a control section to control generation of recommendation information based on log data from an information processing apparatus that communicates with the server over a network, wherein the log data includes data related to behavior of a user and combination data indicating at least one of a keyword or category selected by the user.

### CROSS-REFERENCE TO RELATED APPLICATIONS

The present application claims priority from JP 2011-228452 filed in the Japan Patent Office on Oct. 18, 2011, the disclosure of which is hereby incorporated herein by reference.

### TECHNICAL FIELD

The present disclosure relates to an information processing apparatus, server, information processing system and an information processing method.

### BACKGROUND ART

A company providing goods and services performs various measures for attracting a user (customer) to the provided goods and services. For example, recommendations which provide a user with information which may be of interest to the user, by analyzing Web advertisements, provisions to users of coupons through direct mail, history related to the purchase of goods by the user, and history related to the use of the service, can be included as these measures.

Further, technology related to the attraction of users for such things as provided goods and services has also been developed. For example, the technology described in Patent Literature 1 can be included as technology related to an electronic value distribution system that can enable a publisher of electronic values to acquire a distribution condition of the electronic values.

### CITATION LIST

### Patent Literature

PTL 1: JP 2005-301586A

### Non Patent Literature

NPL 1: Patent Company Publication “Variations of Hand Scanner” Editor Tokkyo Ichiro

### SUMMARY

### Technical Problem

For example, in the case where the technology disclosed in Patent Literature 1 is used, the publisher of the electronic values can comprehend the conditions of the transfer of electronic values, even if the electronic values are assigned among users. In a word, in the case where the technology disclosed in Patent Literature 1 is used, a user who uses electronic values can comprehend the electronic values, even if there is a transfer of electronic values. Therefore, a digital coupon matching the preferences of a user can be provided by using the technology described in Patent Literature 1.

Here, in the case of the technology described in Patent Literature 1, a server, on the side of the publisher of electronic values, updates preference information of the user based on distribution information related to the assignment and transfer of the received digital coupon, and uses the preference information to issue the next digital coupon. Therefore, in the case where the technology described in Patent Literature 1 is used, since the server, on the side of the publisher of electronic values, updates preference information based on the distribution information related to the assignment and transfer of the received digital coupon, updating of the preference information of the user may arise depending on, for example, a digital coupon that the user does not especially intend to use.

Therefore, being able to realize recommendations, which can provide to the user information desired by the user, is not limited even by using the technology described in Patent Literature 1.

The present disclosure proposes a new and improved information processing apparatus, server, information processing system and information processing method that may realize recommendations better reflecting a user's intentions.

### Solution to Problem

According to an embodiment of the present disclosure, there is provided a server that may include a control section to control generation of recommendation information based on log data from an information processing apparatus that communicates with the server over a network, where the log data includes data related to behavior of a user and combination data indicating at least one of a keyword or category selected by the user.

According to an embodiment of the present disclosure, there is provided an information processing method that may include controlling, by a processor, generating of recommendation information based on log data from an information processing apparatus that communicates with the server over a network, where the log data includes data related to behavior of a user and combination data indicating at least one of a keyword or category selected by the user.

According to an embodiment of the present disclosure, there is provided a non-transitory recording medium recorded with a program executable by a computer, where the program may include controlling generating of recommendation information based on log data from an information processing apparatus that communicates with the server over a network, where the log data includes data related to behavior of a user and combination data indicating at least one of a keyword or category selected by the user.

According to an embodiment of the present disclosure, there is provided an information processing apparatus that may include a control unit to control generation of log data, where the log data includes data related to behavior of a user and combination data indicating at least one of a keyword or category selected by the user, and to control transmission of the log data over a network to a server for receiving recommendation information generated from the log data by the server.

According to an embodiment of the present disclosure, there is provided an information processing apparatus that may include a control unit to control display of a display screen as a setting screen for selection of log data, where the log data includes data related to behavior of a user and combination data indicating at least one of a keyword or category selected by the user, where the control unit controls generation of transmission data based on setting information set in accordance with user operation of the setting screen.

### Advantageous Effects of Invention

According to the embodiments of the present disclosure, recommendations better reflecting a user's intentions may be realized.

### BRIEF DESCRIPTION OF DRAWINGS

FIG. 1 is an explanatory diagram showing an example of an information processing system according to a first embodiment;

FIG. 2 is an explanatory diagram showing an example of a setting method of setting information based on a user operation in the information processing apparatus according to the present embodiment;

FIG. 3 is an explanatory diagram showing an example of a setting method of setting information based on a user operation in the information processing apparatus according to the present embodiment;

FIG. 4 is an explanatory diagram showing an example of transmission data generated by the information processing apparatus according to the present embodiment;

FIG. 5 is an explanatory diagram showing an example of an information processing system according to a second embodiment;

FIG. 6 is an explanatory diagram showing an example of a connection among users that can be generated by the information processing system according to the second embodiment;

FIG. 7 is a block diagram showing an example of a configuration of the information processing apparatus according to the present embodiment;

FIG. 8 is an explanatory diagram showing an example of a hardware configuration of the information processing apparatus according to the present embodiment;

FIG. 9 is a block diagram showing an example of a configuration of a server according to the present embodiment; and

FIG. 10 is an explanatory diagram showing an example of a hardware configuration of a server according to the present embodiment.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, the following will be described in the order shown below.

1. An information processing system according to the present embodiment.

2. An information processing apparatus and server according to the present embodiment.

3. A program according to the present embodiment.

<1> Information Processing System According to the First Embodiment

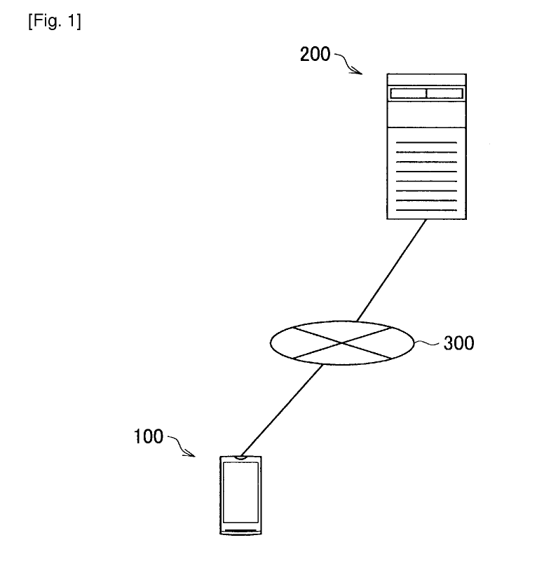

FIG. 1 is an explanatory diagram showing an example of an information processing system according to the first embodiment. The information processing system according to the first embodiment has an information processing apparatus 100 and a server 200, and the information processing apparatus 100 is connected to the server 200 through a network (or directly) by wireless/wires. In FIG. 1, the information processing apparatus 100 and the server 200 show examples of a connection to the network 300.

Here, for example, wired networks such as an LAN (Local Area Network) and WAN (Wide Area Network), wireless networks such as a wireless LAN (WLAN; Wireless Local Area Network) and wireless PAN (WPAN; Wireless Personal Area Network), and a wireless WAN through a base station (WWAN; Wireless Wide Area Network), or the internet using communication protocols such as TCP/IP (Transmission Control Protocol/Internet Protocol), are included as the network 300.

Note that while communication equipment such as a smart phone and a cellular phone are shown in FIG. 1 as the information processing apparatus 100, the information processing apparatus 100 according to the present embodiment is not limited to the example shown in FIG. 1. It is needless to say that the server 200 according to the present embodiment is not limited to the apparatus of the form shown in FIG. 1. Further, while one information processing apparatus 100 is shown in FIG. 1, the configuration of the information processing system according to the first embodiment is not limited to this. For example, the information processing system according to the first embodiment may have a plurality of information processing apparatuses that can each communicate with the server 200.

In the information processing system according to the first embodiment, the information processing apparatus 100 generates transmission data for receiving recommendation information, and sends the generated transmission data to the server 200. Further, in the information processing system according to the first embodiment, the server 200 generates recommendation information by analyzing log data included in the received transmission data, and transmits the generated recommendation information to the information processing apparatus 100.

Here, the recommendation information according to the present embodiment is data showing the contents of recommendations. For example, information of sales, information of recommended goods and services, coupons and the like are included as the contents of the recommendations shown by the recommendation information according to the present embodiment.

Hereinafter, the processes in each of the information processing apparatus 100 and the server 200 will be more specifically described. Note that an example of the configuration of the information processing apparatus 100 and the server 200 according to the present embodiment will be described later.

(Information Processing Apparatus 100)

The information processing apparatus 100 is an apparatus, for example, possessed by a user, and which records a log (a so-called “life log”) related to the behavior of the user to a recording medium such as a storage section (described later).

Here, for example, a log related to a settlement of accounts is included as a log related to the online behavior of the user according to the present embodiment. Also, for example, a log related to the use of transportation facilities and a log showing movement of the information processing apparatus 100 (log corresponding to movement of the user) are included as logs related to the offline behavior of the user according to the present embodiment. The information processing apparatus 100 is provided with a wireless communications antenna circuit and a carrier wave transmission circuit for communicating with an external apparatus through a communications channel formed by NFC (Near Field Communication), which a carrier wave of a prescribed frequency such as 13.56 [MHz] uses to communicate. The information processing apparatus 100 also performs processes related to a settlement of accounts and the use of transportation facilities. Then, the information processing apparatus 100 records a log related to the settlement of accounts and a log related to the use of transportation facilities in accordance with the performed processes. Further, the information processing apparatus 100 is provided with various sensors, such as an acceleration sensor, an angular velocity sensor and a GPS (Global Positioning System) device, and records data showing detection values of these sensors as a log showing movement of the information processing apparatus 100.

The information processing apparatus 100 generates transmission data including the log data, in order to receive recommendation information (data generation process). Then, the information processing apparatus 100 transmits the generated transmission data to the server 200 (transmission process). The information processing apparatus 100 can receive generated recommendation information, based on the transmission data in the server 200, by transmitting data to the server 200.

(1) Data Generation Process

For example, the information processing apparatus 100 generates regular/irregular transmission data based on setting information, which is set based on a user operation.

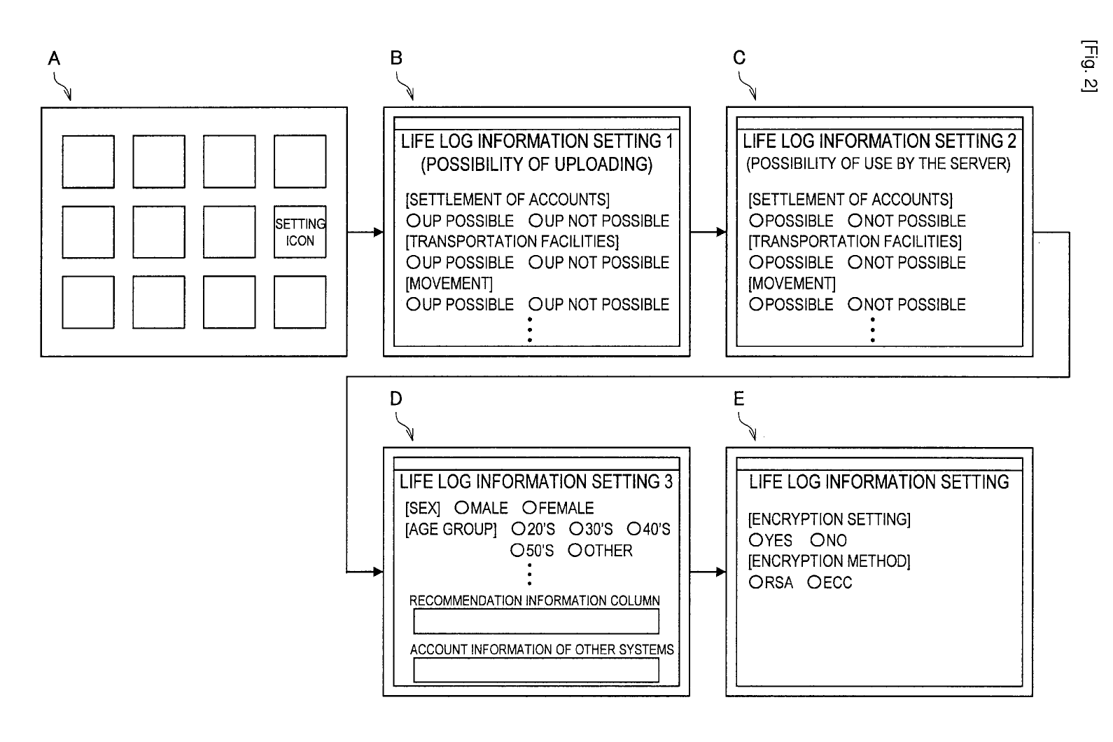

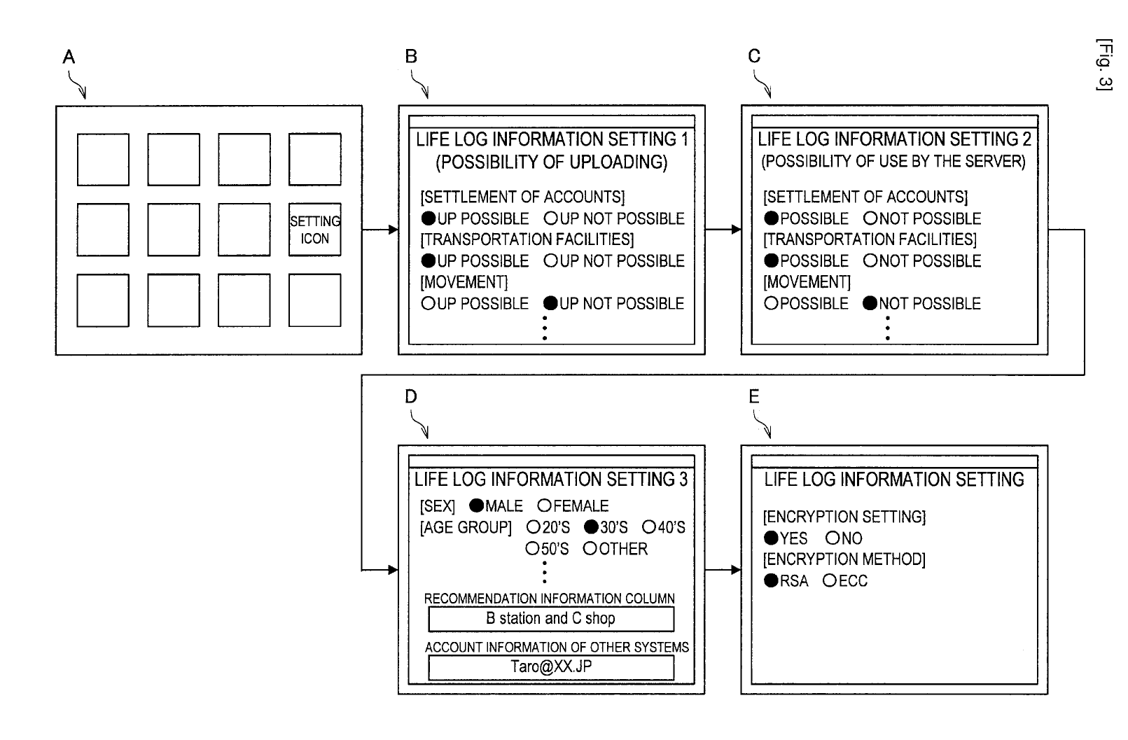

FIGS. 2 and 3 are explanatory diagrams showing an example of a setting method of the setting information based on a user operation, in the information processing apparatus 100 according to the present embodiment. Here, FIGS. 2 and 3 show an example of a setting screen that the information processing apparatus 100 displays on a display screen, where FIGS. 2 and 3 show a state before setting and a state after setting, respectively. Here, the information processing apparatus 100 may display a setting screen on the display screen of a display section (described later), and may display a setting screen on the display screen of an external display apparatus, regardless of whether or not the external apparatus is provided with the display section (described later).

For example, when the user selects a setting icon displayed on the display shown in A of FIG. 2, the information processing apparatus 100 displays the screen shown in B of FIG. 2 on the display screen. Here, the setting screen shown in B of FIG. 2 is a setting screen for the user to select the log data included in the transmission data. The user selects, as shown in B of FIG. 3, for example, whether to include each item corresponding to the log in the transmission data (“up possible” shown in B of FIG. 3), or not to include each item corresponding to the log in the transmission data (“up not possible” shown in B of FIG. 3).

The information processing apparatus 100 can uniquely specify the log data included in the transmission data by the selections made on the setting screen shown in B of FIG. 2.

When the selections on the setting screen shown in B of FIG. 2 are completed, the information processing apparatus 100 will display the screen shown in C of FIG. 2 on the display screen. Here, the setting screen shown in C of FIG. 2 is a setting screen, in the server receiving the transmission data, for a user to set whether or not to use the log data included in the transmission data. The user, as shown in C of FIG. 3, for example, selects whether to permit use of the log data in the server for each item corresponding to the log(“possible” shown in C of FIG. 3), or not to permit use of the log data in the server for each item corresponding to the log(“not possible” shown in C of FIG. 3).

For example, the information processing apparatus 100 can include, in the individual log data, data showing whether or not it is used (for example, control data for a publication setting described later) by the selections made on the setting screen shown in C of FIG. 2.

When the selections on the setting screen shown in C of FIG. 2 are completed, the information processing apparatus 100 will display the screen shown in D of FIG. 2 on the display screen. Here, the setting screen shown in D of FIG. 2 is a setting screen for the user to set an anonymity that (basically) does not immediately specify the user or alternatively specifies the user. Further, the setting screen shown in D of FIG. 2 is a setting screen for the user to set a combination of the log data that can be used in the server (for example, a condition amounting to receiving recommendations).

As shown in D of FIG. 3, for example, the user selects such things as sex and age group, and inputs such things as an account (“account information of other systems” shown in D of FIG. 3) related to the services of an SNS (Social Networking Service), an online purchasing, ranking or reviewing service or the like. Here, D of FIG. 3 shows an example where the user has selected “male” as their sex, “30's” as their age group, and has set “Taro@XX.JP” as their account. The information processing apparatus 100 can include anonymous information for managing a user associated with the services in the transmission data, by the selections and inputs made on the setting screen shown in D of FIG. 2, as above.

Further, the user inputs a condition (“recommendation setting column” shown in FIG. 3) of the combination of the log data that can be used in the server. Here, D of FIG. 3 shows an example where the user has set “B station and C shop” as the conditions. The information processing apparatus 100 can include combination information in the transmission data by the inputs of the conditions made on the setting screen shown in D of FIG. 2, as above. Here, in the information processing system according to the first embodiment, the server 200, which has received the transmission data, generates recommendation information by analyzing the transmission data. Therefore, the user can receive recommendations, for example, “when alighting at station B and using shop C” by setting the conditions of the combinations of the log data that can be used in the server, as shown in D of FIG. 3, for example.

When the selections on the setting screen shown in D of FIG. 2 are completed, the information processing apparatus 100 will display the screen shown in E of FIG. 2 on the display screen. Here, the setting screen shown in E of FIG. 2 is a setting screen for a user to make a setting related to the encryption of the transmission data. The user, as shown in E of FIG. 3, for example, makes a selection of whether to encrypt the transmission data (“yes” of the “encryption setting” shown in E of FIG. 3) or not to encrypt the transmission data (“no” of the “encryption setting” shown in E of FIG. 3), and makes a selection of the encryption method (for example, “RSA” (Rivest Shamir Adleman) or “ECC” (Elliptic Curve Cryptography) shown in E of FIG. 2).

For example, the information processing apparatus 100 can include the presence or absence of the encryption of the transmission data and, when encrypted, encryption information showing the method of encryption in the transmission data, by the selections made on the setting screen shown in E of FIG. 2.

The information processing apparatus 100, as shown in FIG. 3, for example, records the setting information showing the selection contents and input contents of the user to a recording medium such as a storage section (described later), based on a user operation made on the setting screen (corresponding to setting of the setting information). Here, the information processing apparatus 100 according to the present embodiment may newly create setting information for each user operation made on the setting screen, and may update the stored setting information for each user operation made on the setting screen.

Note that the information processing apparatus 100 according to the present embodiment is not limited to the example setting screen, displayed for setting the setting information, shown in FIGS. 2 and 3. For example, the information processing apparatus 100 displays a setting screen corresponding to the information included in the transmission data. To give one example, the information processing apparatus 100 may not display, for example, the setting screen shown in E of FIG. 2 in the case where encryption information is not included in the transmission data. Further, the information processing apparatus 100 according to the present embodiment is not limited to the example layout of the displayed setting screen and the example contents of the individual setting screens shown in FIGS. 2 and 3. For example, while D of FIG. 2 and D of FIG. 3 show examples of a setting screen for the user to input conditions of the combinations of the log data that can be used in the server (“recommendation setting column” shown in D of FIG. 3), the information processing apparatus 100 according to the present embodiment may display a setting screen enabling the user to select combinations on the display screen.

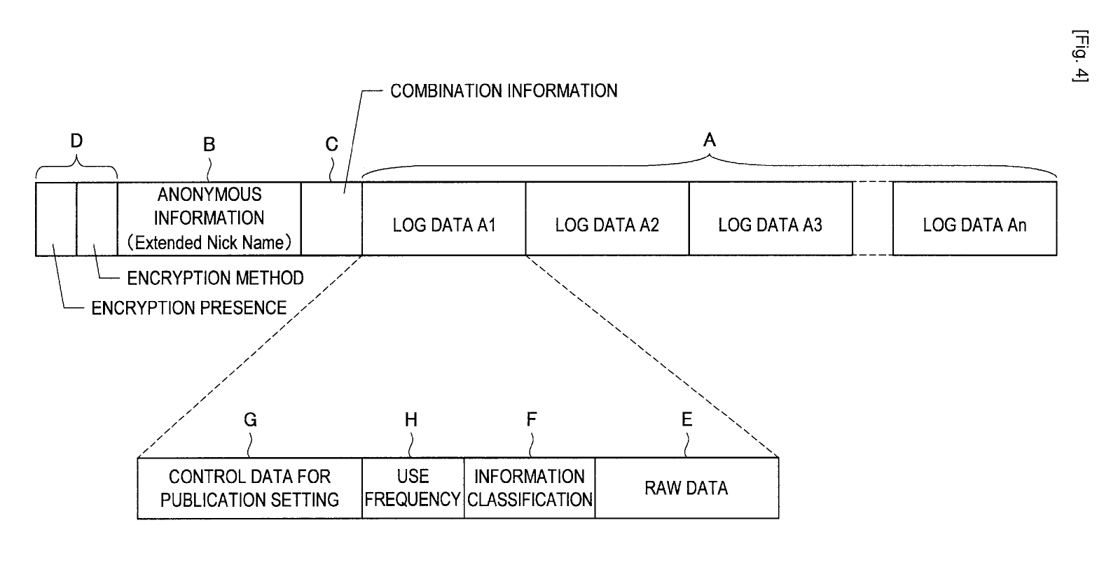

The information processing apparatus 100 generates transmission data, based on the setting information that has been set in accordance with the user operation on the setting screen shown in FIGS. 2 and 3, for example. FIG. 4 is an explanatory diagram showing an example of the transmission data generated by the information processing apparatus according to the present embodiment. Here, FIG. 4 shows an example of the transmission data that the information processing apparatus 100 has set, based on the setting information that has been set in accordance with the user operation on the setting screen shown in FIG. 3.

The transmission data shown in FIG. 4 has a plurality of log data (A shown in FIG. 4), anonymous information (B shown in FIG. 4), combination information (C shown in FIG. 4), and encryption method information (D shown in FIG. 4). Further, each of the data logs shown in FIG. 4 has raw data (E shown in FIG. 4), an information classification showing the classification of the raw data (F shown in FIG. 4), control data for a publication setting showing whether or not to use the log data (G shown in FIG. 4), and a use frequency showing an accumulated recording frequency of the log (H shown in FIG. 4). For example, data showing the date, an amount of the settlement of accounts, a classification of the settlement of accounts, a location and the like are included as the raw data. For example, information showing purchase information, location information, movement and the like are included as the information classifications.

Here, the log data included in the transmission data is log data corresponding to items that are selected as being included in the transmission data, in the setting screen shown in B of FIG. 3. For example, the user can control, by their own volition, the transmission of log data to the server, by the information processor 100 generating transmission data including the log data corresponding to the user operation on the setting screen shown in B of FIG. 3, for example.

Further, the control data for a publication setting showing whether or not to use the log data, which has been set on the setting screen shown in C of FIG. 3, is included in the log data included in the transmission data. Therefore, the use in the server of the individual log data included in the transmission data can be controlled, by the user's own volition.

Further, for example, in the information processing system according to the first embodiment, the quality of the recommendations in accordance with the purchase frequency of goods, the use frequency of a service, or the like are modified and dynamic recommendations may be realized, by including the use frequency showing the accumulated recording frequency of the log (E shown in FIG. 4), in the log data included in the transmission data. Here, for example, changing the contents of the recommendation information, in accordance with whether or not the accumulated recording frequency shown by the use frequency included in the log data is at or above a prescribed threshold (or whether or not it is larger than a prescribed threshold), is included as the dynamic recommendations according to the present embodiment

Further, for example, the combination information included in the transmission data shows the log data corresponding to the conditions input by the user, on the setting screen shown in D of FIG. 3. While the combination information shows, for example, a label (A1, . . . , An attached to each log data shown in FIG. 4) of the log data that is selected as being permitted to use the log data in the server, the combination information according to the present embodiment is not limited to this. For example, conditions (character strings) input by the user, on the setting screen shown in D of FIG. 3, may be contained in the condition information according to the present embodiment.

For example, the user can control, by their own volition, the use of the log data in the server, by the information processing apparatus 100 generating transmission data containing combination information corresponding to a user operation on the setting screen shown in D of FIG. 3, for example. Further, for example, in the information processing apparatus 100, recommendation information, based on the log data generated in the server 200 and to which use is permitted, is received, by the information processing apparatus 100 generating the transmission data containing the combination information corresponding to the user operation on the setting screen shown in C of FIG. 3, for example, and transmitting the transmission data to the server 200. Therefore, for example, the user can receive desired recommendations having a high possibility of agreeing with the user's preferences, by the information processing apparatus generating transmission data containing the combination information corresponding to the user operation on the setting screen shown in C of FIG. 3, for example.

Further, the anonymous information included in the transmission data shows the selection contents and contents of inputs on the setting screen in D of FIG. 3. For example, the user can conceal (not being immediately specified), by their own volition, the log shown by the log data that is a log relating to the user themselves, by the information processing apparatus 100 generating transmission data containing the anonymous information corresponding to the user operation on the setting screen shown in D of FIG. 3.

Further, for example, the encryption method information included in the transmission data shows the presence or absence of a selected encryption and the method of encryption, on the setting screen shown in E of FIG. 3. For example, the information processing apparatus 100 encrypts the generated transmission data by a method of encryption shown by the encryption method information. For example, the user can control, by their own volition, the presence or absence of encryption and the method of encryption, by the information processing apparatus 100 generating transmission data containing encryption method information corresponding to the user operation on the setting screen shown in D of FIG. 3, for example.

For example, the information processing apparatus 100 generates transmission data, such as that shown in FIG. 4, based on the setting information. Note that the information processing apparatus 100 according to the present embodiment is not limited to the example shown in FIG. 4 of generating transmission data. For example, the information processing apparatus 100 can generate transmission data that does not contain the encryption method information shown in D of FIG. 4, or the information processing apparatus 100 can generate transmission data including log data that does not contain the use frequency shown in E of FIG. 4. Further, for example, the information processing apparatus 100 may generate transmission data that does not contain the anonymous information.

(2) Transmission Process

The information processing apparatus 100 transmits the transmission data generated in the process of (1) above (data generation process) to the server 200. Here, for example, the information processing apparatus 100 transmits the transmission data, based on destination information showing an external apparatus that can generate the recommendation information. For example, data showing an external apparatus, such as an IP (Internet Protocol) address or an MAC (Media Access Control) address, is included as the destination information according to the present embodiment.

For example, the information processing apparatus 100, by performing the process of (1) above (data generation process) and the process of (2) (transmission process), generates transmission data for receiving recommendation information reflecting a user's intentions, and transmits the generated transmission data to the server 200. Then, the information processing apparatus 100 receives the generated recommendation information, based on the transmission data in the server 200.

(Server 200)

In the case where the server 200 receives the transmission data transmitted from the information processing apparatus 100, the server 200 analyzes the received transmission data (analysis process). Then, for example, the server 200 transmits related information, which relates to a user for whom the anonymous information included in the transmission data is shown, to an external apparatus (transmission process). Here, in the case where anonymity is set for the anonymous information included in the transmission data, the related information transmitted by the server 200 to an external device relates to an anonymous user for whom the anonymous information is shown. Further, in the case where anonymity is not set for the anonymous information included in the transmission data, for example, a customer invitation from the recommendation information, without joining other services, such as the previously described SNS, may be realized.

(I) Analysis Process

In the case where the server 200 receives the transmission data, the server 200 analyzes, for example, the log data corresponding to the combination information, from within the entire log data, on the basis of the combination information included in the transmission data. In the case where the received data transmission is encrypted, the server 200 analyzes the log data corresponding to the combination information after decrypting the transmission data. Then, based on the analysis results, the server 200 generates recommendation information as the related information. Here, for example, various statistical processes of each user, for whom anonymous information included in transmission data is shown, a behavior analysis process, a preference analysis process and the like are included as the analysis processes of the log data in the server 200. Note that the analysis process of the log data in the server 200 is not limited to the above. For example, the server 200 may perform various statistical processes intended for all users.

Here, the server 200 analyzes, from within the entire log data included in the transmission data, the log data corresponding to the combination information, and generates recommendation information. In a word, the server 200 sets as a process target the log data corresponding to the combination information. Therefore, the server 200 can further reduce the processing load related to the analysis of the log data and the generation of the recommendation information.

Further, since the server 200 generates, from within the entire log data included in the transmission data, recommendation information based on the log data corresponding to the combination information, the server 200 can generate recommendation information that has a high possibility of agreeing with the user's preferences.

Note that the analysis process in the server 200 is not limited to analyzing the log data corresponding to the combination information, from within the entire log data, based on the combination information included in the transmission data. For example, the server 200 may refer to the control data for a publication setting, configuring individual log data included in the transmission data, and in the case where the control data for a publication setting is shown to be usable, the server 200 may analyze the log data that is usable, and generate recommendation information corresponding to the analysis result.

(II) Transmission Process

The server 200 transmits the recommendation information generated in the process of (I) above (analysis process) to the information processing apparatus 100, which is the external apparatus that transmitted the transmission data.

For example, the server 200, by performing the process of (I) above (analysis process) and the process of (II) (transmission process), generates recommendation information reflecting the user's intentions and which has a high possibility of agreeing with the user's preferences, and transmits the generated recommendation information to the information processing apparatus 100.

As stated above, in the information processing system according to the first embodiment, the information processing apparatus 100 generates transmission data for receiving recommendation information reflecting the user's intentions, and transmits the generated transmission data to the server 200. Further, in the information processing system according to the first embodiment, the server 200 generates recommendation information by analyzing the log data included in the received transmission data, and transmits the generated recommendation information to the information processing apparatus 100. Then, in the information processing system according to the first embodiment, the information processing apparatus 100 receives the recommendation information transmitted from the server 200.

Here, for example, the server 200 generates recommendation information based on the log data corresponding to the combination information, from within the entire log data included in the transmission data. Further, for example, the server 200 may generate recommendation information, based on the log data showing that the control data for a publication setting is usable, from within the entire log data included in the transmission data. Therefore, the contents of the recommendations shown by the recommendation information received by the information processing apparatus 100 reflects the user's intentions and has a high possibility of agreeing with the user's preferences.

Therefore, for example, recommendations reflecting the user's intentions may be realized by the information processing system according to the first embodiment.

Further, for example, in the information processing system according to the first embodiment, the server 200 sets as a process target the log data corresponding to the combination information, from within the entire log data included in the transmission data, and the log data showing that the control data for a publication setting is usable, from within the entire log data included in the transmission data. Therefore, in the information processing system according to the first embodiment, the processing load related to the analysis of the log data and the generation of the recommendation information is further reduced in the server 200.

(Application Example of the Information Processing System According to the First Embodiment)

For example, (i) and (ii) below may be realized by the information processing system according to the first embodiment shown in FIG. 1, for example. It is needless to say that the application example of the information processing system according to the first embodiment is not limited to the examples shown in (i) and (ii) below.

(i)

The server 200 successively receives transmission data from the information processing apparatus 100.

The server 200 refers to the control data for a publication setting, which configures the log data included in the received transmission data, and a log to which use is not permitted is not set as the target of the recommendations. For example, in the case where the use condition of information for the settlement of accounts and examination of tickets becomes usable, the server 200 does not set an analysis target by which other logs make recommendations.

Further, for example, the server 200 generates recommendation information to a point where the log data in agreement with the condition is complete, based on the setting of the combination information included in the received transmission data, and the server 200 transmits the recommendation information to the information processing apparatus 100, which transmits the transmission data. For example, In the case where the combination information shows “B station” and “C shop”, by an analysis of the log data included in the transmission data, and at the time when the user alights at station B and the use of shop C is identified, the server 200 transmits, for example, information showing sales in a shopping district adjacent to station B and coupon information, as the recommendation information to the information processing apparatus 100.

Further, the server 200 may further generate recommendation information including high premium coupon information corresponding to the use frequency in the above combination, based on the use frequency included in the transmission data, for example, and the server 200 may transmit the generated recommendation information to the information processing apparatus 100. As shown above, for example, a customer invitation capability for goods and services can be improved by the server 200 generating the recommendation information based on the use information included in the transmission data.

(ii)

In the case where the information processing apparatus 100 includes a wireless communications antenna circuit and a carrier wave transmitting circuit, for communicating with an external unit by a communications channel formed by NFC, the information processing apparatus 100 transmits, for example, transmission data including a log of when the user has used a basic resident registration card (an example of an IC card for obtaining public services) represented by Type-B (an example of a log related to the behavior of the user), to the server 200. Further, for example, in the case where the user borrows a book from library D using the basic resident registration card, and uses shop E, the server 200 generates recommendation information including coupon information that can be used at the shopping district to which shop E belongs, and transmits the generated recommendation information to the information processing apparatus 100, by performing the above process of receiving the transmission data.

[2] The Information Processing System According to the Second Embodiment

The information processing system according to the present embodiment is not limited to the information processing system according to the first embodiment above. For example, as shown in D of FIG. 3, the information processing apparatus according to the present embodiment can be provided with a column that inputs account information related to a service, such as an SNS, to in the setting screen displayed on the display screen. Further, the information processing system according to the present embodiment generates transmission data including anonymous information showing the input content of the user on the setting screen shown in D of FIG. 3, for example, and transmits the generated transmission data to the server according to the present embodiment. In a word, for example, the server according to the present embodiment can co-operate with other services, such as an SNS (or a system realizing these other services), by using the anonymous information included in the received transmission data. Here, the information processing system, which may realize recommendations reflecting the user's intentions while aiming for co-operation with other services, such as an SNS, is described next as the information processing system according to the second embodiment.

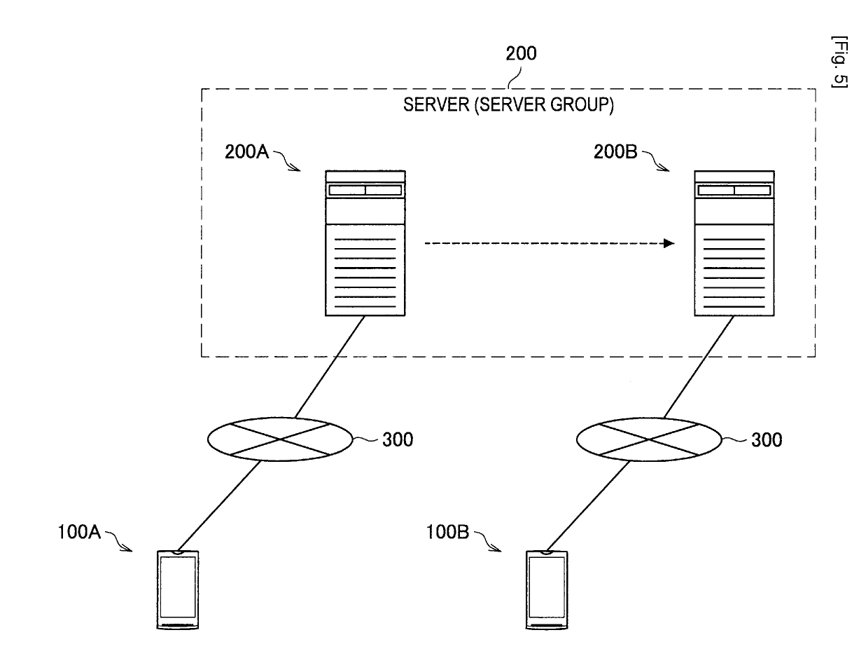

FIG. 5 is an explanatory diagram showing an example of the information processing system according to the second embodiment. The information processing system according to the second embodiment has an information processing apparatus 100A, an information processing apparatus 100B, and a server 200, and the information processing apparatuses 100A and 100B are respectively connected to the server 200 through a network (or directly) by wireless/wires. FIG. 5 shows an example of the information processing apparatuses 100A and 100B respectively connected to the server 200 by a network 300.

Further, FIG. 5 shows an example of the server 200 as a server group having a server 200A and a server 200B. Note that the server according to the present embodiment, configuring the information processing system according to the second embodiment, is not limited to the server group shown in FIG. 5. For example, the server according to the present embodiment, configuring the information processing system according to the second embodiment, may be one server having the function of the server 200A and the server 200B described later.

The information processing apparatus 100A has a function similar to that of the information processing apparatus 100, configuring the information processing system of the first embodiment shown in FIG. 1, and transmits the transmission data to the server 200.

Further, the information processing apparatus 100B may or may not have a function similar to that of the information processing apparatus 100, configuring the information processing system of the first embodiment shown in FIG. 1.

The following describes, by including an example, the case where the server 200 processes the transmission data transmitted from the information processing apparatus 100A. In a word, FIG. 5 shows an example where the server 200 is a server group having the server 200A (an example of a first server) communicating with the information processing apparatus 100A, which transmitted the transmission data, and the server 200B (an example of a second server) communicating with the server 200A.

In the case where the server 200 receives transmission data transmitted from the information processing apparatus 100A, for example, the server 200 analyzes the received transmission data (analysis process). Then, for example, the server 200 transmits related information, which relates to the user for whom the anonymous information included in the transmission data is shown (transmission process).

To be more specific, the server 200 manages the log data corresponding to the combination information, from within the entire log data included in the transmission data transmitted from the information processing apparatus 100A, for each user based on the anonymous information included in the transmission data. Then, the server 200 transmits the log data corresponding to a transmission request transmitted from an external apparatus as related information, which relates to the user for whom the anonymous information is shown, to the external apparatus that transmitted the transmission request. Here, for example, the transmission request according to the present embodiment is one type of instruction for transmitting from an apparatus that can communicate with the server 200, such as the information processing apparatus 100B, and for performing transmission of the log data to the server 200. For example, data showing identification information that shows a user, location or the like corresponding to the log data requesting transmission (for example, an ID showing an account name, location or the like), and instructions are included in the transmission request according to the present embodiment.

Further, as shown in FIG. 5, in the case where the server 200 is a server group having the server 200A (an example of a first server) and the server 200B (an example of a second server), the server 200 performs the following processes to each of the server 200A and the server 200B.

For example, in the case where the server 200A receives the transmission data transmitted from the information processing apparatus 100A, the server 200A transmits the anonymous information included in the transmission data and the log data corresponding to the combination information, from within the entire log data included in the transmission data, to the server 200B. Further, for example, the server 200A may transmit the anonymous information included in the transmission data and the log data showing that the control data for a publication setting is usable, from within the entire log data included in the transmission data, to the server 200B.

Here, for example, in the case where information of an account related to other services provided in the server 200B, such as an SNS, is set to anonymous information, the server 200A transmits the anonymous information and the log data to the server 200B. In the server 200, as shown above, for example, the process related to co-operation with other services, such as an SNS, is performed by setting information related to the other services, such as information of the account, to anonymous information included in the transmission data. Note that the server 200A may transmit the anonymous information and the log data to the server 200A of a target performing co-operation, regardless of the setting contents of the anonymous information.

As above, for example, the server 200A selectively transmits the anonymous information included in the received transmission data, and the log data corresponding to a log that is permissible by the user of the information processing apparatus 100A, from within the entire log data contained in the transmission data, to the server 200B.

Note that the processes in server 200A are not limited to the above. For example, in the case where the server 200A receives the transmission data transmitted from the information processing apparatus 100A, the server 200A can transmit the entire log data included in the transmission data to the server 200. Further, the server 200A may have a function similar to that of the server 200 related to the information processing system according to the first embodiment described above. In the case where the server 200A has a function similar to that of the server 200 related to the information processing system according to the first embodiment described above, the server 200A generates recommendation information based on the transmission data received from the information processing apparatus 100A, and transmits the generated recommendation information to the information processing apparatus 100A.

The server 200B receives the anonymous information and the log data transmitted from the server 200A. Here, from the point of view of the server 200A, the anonymous information and the log data transmitted from server 200A correspond to the transmission data transmitted from the server 200A. When the anonymous information and the log data transmitted from the server 200A are received, the server 200B manages the log data received from the server 200A for each user, based on the received anonymous information. For example, recording a log shown by the log data to a table provided for each user is included as a managing method of the log data in the server 200B.

Further, in the case where the server 200B receives a transmission request, transmitted from an external apparatus such as the information processing apparatus 100B, the server 200B transmits the log data corresponding to the received transmission request to the external apparatus that transmitted the transmission request. Here, for example, while the server 200B includes transmitting the log data corresponding to the transmission request to the external apparatus as the transmission of the log data corresponding to the transmission request in the server 200B according to the present embodiment, the process in the server 200B is not limited to this. For example, the server 200B may process the log data corresponding to the transmission request into data to be displayed or the like, and may transmit the log data after processing to the external apparatus.

Here, for example, in the case where the server 200B transmits the log data, as part of a process related to the provisions of an SNS service, to the external apparatus that transmitted the transmission request, the user of the external apparatus that received the log data makes a comment on the log shown by the log data, and a response to the log shown by the data can be generated. In a word, a connection among users related to the log data may be generated, by the server 200B transmitting the log data, as related information relating to the user, to the external apparatus. In another example, the server 200A may receive from a server, such as the server 200B, that provides a service of a system, such as of a social networking service or an online purchasing, ranking or reviewing service, log data relating to information relating to the use of the service of the system by the user, such as information related to the user from an account of the user with the system.

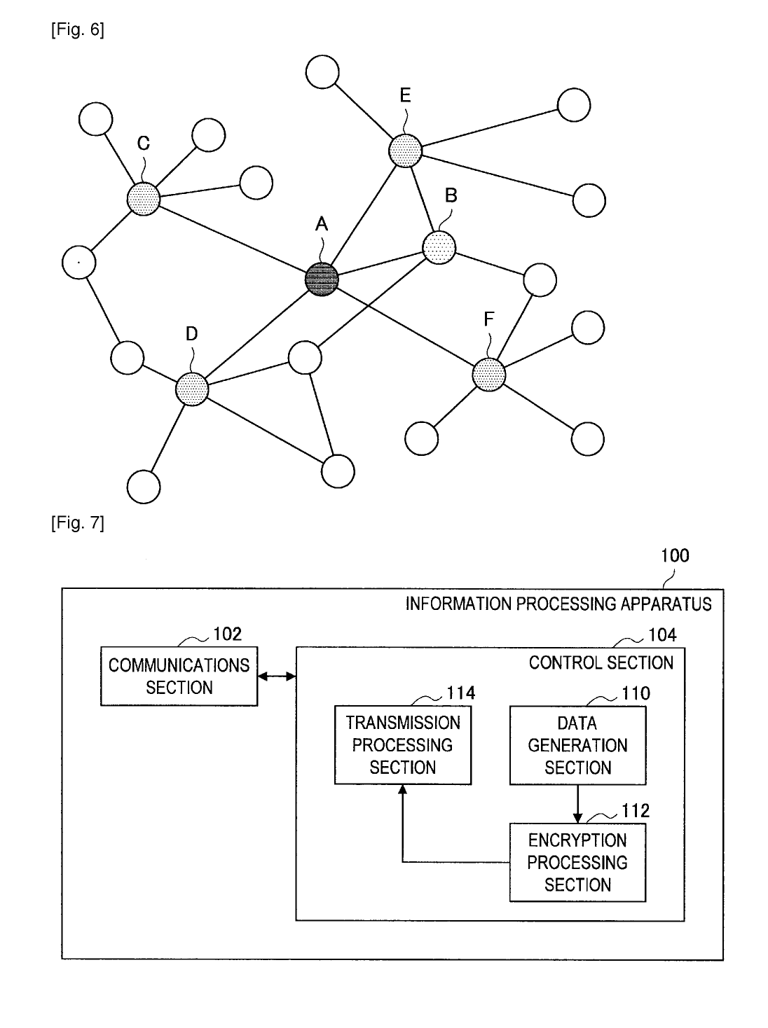

FIG. 6 is an explanatory diagram showing an example of the connection among users that can be generated by the information processing system according to the second embodiment. Here, A shown in FIG. 6 shows the user of the information processing apparatus 100A, and B shown in FIG. 6 shows the user of the information processing apparatus 100B.

A user with a strong information transmitting capability, a so-called “preacher”, exists in an SNS or the like (for example, the user shown in C-F of FIG. 6). For example, the log shown by the log data included in the transmission data, which the information processing apparatus 100A transmitted to server 200A, is mediated, and a larger connection among users is generated, by transmitting the log data as related information, which relates to the user, to an external apparatus possessed by the user, such as shown in C-F of FIG. 6.

Here, for example, in the case where the log shown by the log data, which the server 200B transmitted to the external apparatus, is a log relating to a purchase in shop C, the user can go to purchase something in shop C by connecting among users, as mediators, such things as logs relating to purchases in shop C and comments on this log. In a word, the customer invitation capability of shop C, for example, is improved by the server 200B transmitting the log data, as related information relating to the user, to an external apparatus. Therefore, the log data, as related information relating to the user, which the server 200B transmits to an external apparatus, can be captured as a type of recommendation information.

In the information processing system according to the second embodiment, as above, for example, co-operation with other users of an SNS or the like can be aimed for in the server 200, by setting information relating to other users, such as information of accounts related to other users of an SNS or the like, in the anonymous information included in the transmission data transmitted from the information processing apparatus 100A. Here, in the server 200 shown in FIG. 5, the server 200A selectively transmits the log data corresponding to a log, which is permissible by the user of the information processing apparatus 100A, to an external apparatus, and the server 200B transmits the log data corresponding to the log that is permissible by the user, as related information relating to the user, to an external apparatus. Further, the log data, as related information relating to the user, which the server 200B transmits to an external unit, can function as a type of recommendation information.

Therefore, in the information processing system according to the second embodiment shown in FIG. 5, for example, recommendations reflecting the user's intentions may be realized along with aiming for co-operation with other services, such as an SNS.

Further, in the server shown in FIG. 5, as above, the server 200A selectively transmits the log data corresponding to a log that is permissible by the user of the information processing apparatus 100A to the server 200B. Therefore, in the information processing system according to the second embodiment, a decrease of the processing load in the server 200B can be aimed for.

(Application Example of the Information Processing System According to the Second Embodiment)

For example, (iii) below may be realized by the information processing system according to the second embodiment shown in FIG. 5, for example. Note that the application example of the information processing system according to the second embodiment is not limited to the example shown in (iii) below. For example, the server 200A and the server 200B shown in (iii) below may be one server.

(iii)

Anonymous information showing “hanako@XX.jp” and log data showing purchases from shop C at a certain time are transmitted to the server 200A from the information processing apparatus 100A.

The server 200A that received the transmission data analyzes the log data included in the transmission data.

The server 200A transmits the anonymous information and the log data to the server 200B performing the processes related to the provisions of an SNS service.

The server 200B that received the anonymous information and the log data records the log data of “hanako@XX.jp”, shown by the anonymous information, to a table for “hanako@XX.jp”. Then, the server 200B shares the log data related to “hanako@XX.jp” among specific or non-specific users of the SNS service.

A user (“tara@xx.jp”) of the information processing apparatus 100B, who is a user of the SNS service, operates the information processing apparatus 100B, and transmits a transmission request, for transmitting the log data of the server 200B and “hanako@XX.jp” to the information processing apparatus 100B.

For example, the information processing apparatus 100B, which received the log data of “hanako@XX.jp” transmitted from the server 200B in accordance with the transmission request, displays the contents of the log shown by the received log data on a display screen. The user of the information processing apparatus 100B (“taro@xx.jp”) inspects the log of “hanako@XX.jp” displayed on the display screen. The user of the information processing apparatus 100B creates a comment on the contents of the log of “hanako@XX.jp”. Then, the user of the information processing apparatus 100B transmits data showing the comment on the contents of “hanako@XX.jp” in the information processing apparatus 100B to the server 200B.

In the case where the user of the information processing apparatus 100B (“taro@xx.jp”) is at the position of a “preacher” having an influence in the SNS service, the comment on the contents of the log of “hanako@XX.jp”, created by the user of the information processing apparatus 100B, has a high probability of influencing other users who are using the SNS service. Therefore, a customer can be invited to shop C by raising the purchasing considerations of other users who use the SNS service, as mediating “a log of a purchase from shop C at a certain time” of the user who uses “hanako@XX.jp” as anonymous information and the comments on this log.

(Information Processing Apparatus and Server According to the Present Embodiment)

Next, an example of the configurations of the information processing apparatus 100 and the server 200, which can configure the information processing system according to the present embodiment, are described.

(Information Processing Apparatus According to the Present Embodiment)

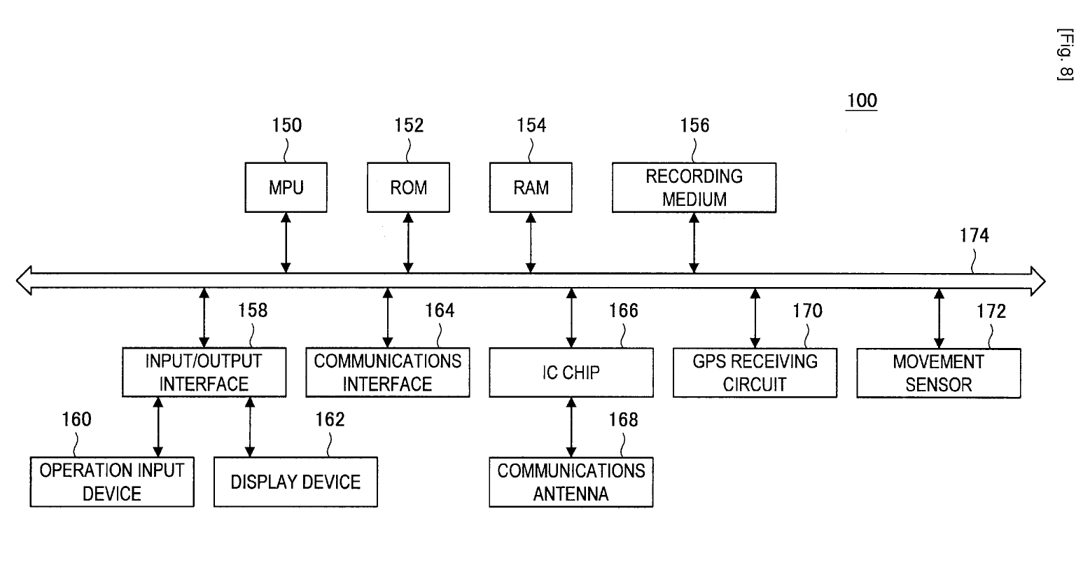

FIG. 7 is a block diagram showing an example of the configuration of the information processing apparatus 100 according to the present embodiment. For example, the information processing apparatus 100 includes a communications section 102 (apparatus side communications section) and a control section 104.

The information processing apparatus 100 may also include, for example, ROM (Read Only Memory; not shown), RAM (Random Access Memory; not shown), a storage unit (not shown), an operation unit (not shown) that can be operated by the user, and a display unit (not shown) that displays various screens in the display screen. The information processing apparatus 100 connects each of the above structural elements by, for example, a bus as a transmission path of data.

The ROM (not shown) stores programs and control data such as arithmetic parameters used by the control unit 104. The RAM (not shown) temporarily stores programs executed by the control unit 104 and the like.

The storage unit (not shown) is a storage means included in the information processing apparatus 100 and stores various kinds of data, for example, setting information, electronic value such as electronic money, and applications. As the storage unit (not shown), for example, a magnetic recording medium such as a hard disk and nonvolatile memory such as EEPROM (Electrically Erasable and Programmable Read Only Memory) and flash memory can be cited. In addition, the storage unit (not shown) may be a recording medium having tamper resistance built within an IC chip capable of communicating wirelessly with a reader/writer (or a device with function of a reader/writer), which transmits a carrier wave of a prescribed frequency such as 13.56 [MHz]. The storage unit (not shown) may be removable from the information processing apparatus 100.

Examples of the operation unit (not shown) include a button, a direction key, a rotary selector such as a jog dial, and a combination thereof. In addition, the information processing apparatus 100 can connect to an operation input device (e.g., a keyboard or a mouse) as an external device of the information processing apparatus 100.

Examples of the display unit (not shown) include a liquid crystal display (LCD) and an organic EL display (also referred to as an organic ElectroLuminescence display or an OLED display (Organic Light Emitting Diode display)). Alternatively, the display unit (not shown) may be a device that can display information and can be operated by a user such as a touch screen, for example. Further, the information processing apparatus 100 can connect to a display device (e.g., an external display) as an external device of the information processing apparatus 100 regardless of whether it has a display unit (not shown) or not.

(Exemplary Hardware Configuration of the Information Processing Apparatus 100)

FIG. 8 is an explanatory diagram showing an exemplary hardware configuration of the information processing apparatus 100 in accordance with this embodiment. The information processing apparatus 100 includes, for example, a MPU 150, ROM 152, RAM 154, a recording medium 156, an input/output interface 158, an operation input device 160, a display device 162, and a communication interface 164. In addition, the information processing apparatus 100 connects each of the aforementioned components via a bus 166 serving as a data transmission channel, for example.

The MPU 150 functions as, for example, a MPU (Micro Processing Unit) and a control unit 104 that includes various processing circuits and the like and controls the entire information processing apparatus 100. In addition, the MPU 150 functions as a data generation section 110, an encryption processing section 112, and a transmission processing section 114 described below, for example, in the information processing apparatus 100.

The ROM 152 stores programs used by the MPU 150, control data such as operation parameters, and the like. The RAM 154 temporarily stores programs executed by the MPU 150, for example.

The recording medium 156 functions as a storage unit (not shown), and stores various data such as setting information and applications, for example. Herein, examples of the recording medium 156 include a magnetic recording medium such as a hard disk and nonvolatile memory such as flash memory. In addition, the recording medium 156 may be removable from the information processing apparatus 100.

The input/output interface 158 connects the operation input device 160 and the display device 162, for example. The operation input device 160 functions as an operation unit (not shown), and the display device 162 functions as a display unit (not shown). Herein, examples of the input/output interface 158 include a USB (Universal Serial Bus) terminal, a DVI (Digital Visual Interface) terminal, a HDMI (High-Definition Multimedia Interface) terminal, and various processing circuits. The operation input device 160 is provided on the information processing apparatus 100, for example, and is connected to the input/output interface 158 in the information processing apparatus 100. Examples of the operation input device 160 include a button, a direction key, a rotary selector such as a jog dial, and a combination thereof. In addition, the display device 162 is provided on the information processing apparatus 100, for example, and is connected to the input/output interface 158 in the information processing apparatus 100. Examples of the display device 162 include a liquid crystal display and an organic EL display.

Note that it is needless to mention that the input/output interface 158 may also connect to an external device such as an operation input device (e.g., a keyboard or a mouse), a display device, or an imaging device as an external device of the information processing apparatus 100. In addition, the display device 162 may be a device that can display information and can be operated by a user such as a touch screen, for example.

The communication interface 164 is a communication means of the information processing apparatus 100, and functions as the communication unit 102 for performing wire/wireless communication with an external device such as a server like the server 200, the shared application server 500, or the market server 600, for example, via the network 300 (or directly). Herein, examples of the communication interface 164 include a communication antenna and an RF (Radio Frequency) circuit (wireless communication); an IEEE 802.15.1 port and a transmission/reception circuit (wireless communication); an IEEE 802.11b port and a transmission/reception circuit (wireless communication); and a LAN (Local Area Network) terminal and a transmission/reception circuit (wire communication).

The IC chip 166 may realize various functions related to transmission as an integrated circuit, by a transmission channel formed by NFC, for example. Here, for example, the IC chip 166 is connected with the communications antenna 168, which is configured by a resonant circuit including a coil having a prescribed inductance and a capacitor having a prescribed electrostatic capacity as a transmission/reception antenna, and the IC chip 166 communicates by the transmission channel formed by NFC through the communications antenna. For example, a demodulator circuit and regulator, a load modulation circuit which performs selective load modulation configured by a load resistance and switching circuit, a processing circuit which controls various data processes and the load modulation, and memory devices that can store data, are included as circuits accumulating the IC chip 166. Further, the IC chip 166 may be further provided with a carrier detection circuit which generates a rectangular detection signal for detecting the reception of a carrier wave based on a certain received voltage that the communications antenna 168 generates by electromagnetic induction corresponding to the reception of the carrier wave. For example, the IC chip 166 can detect the reception of a carrier wave by transmitting the above detection signal to the processing circuit.

The GPS reception circuit 170 is provided in the information processing apparatus 100, and is a circuit which acquires the log showing the movement of the image processing apparatus 100 (a log corresponding to the movement of the user). For example, the GPS reception circuit 170 detects the position of the image processing apparatus 100 by using a received signal from a GPS satellite.

The movement sensor 172 is provided in the information processing apparatus 100 and is a sensor which acquires the log showing the movement of the image processing apparatus 100 (a log corresponding to the movement of the user). An acceleration sensor and an angular velocity sensor are included as the movement sensor 172.

The information processing apparatus 100, by the configuration shown in FIG. 8, for example, performs the processes of the process (1) (data generation process) and the process (2) (transmission process) related to the information processing method in the information processing apparatus according to the present embodiment. Note that the hardware configuration of the information processing apparatus 100 according to the present embodiment is not limited to the configuration shown in FIG. 8.

For example, the information processing apparatus 100 can be configured without providing one, or two or more of, for example, the operation device 160, the display device 162, the IC chip 166 and the communications antenna 168, the GPS reception circuit 170 and the movement sensor 172.

Referring again to FIG. 7, an example of the configuration of the information processing apparatus 100 is described. The communications section 102 is a communications section provided by the information processing apparatus 100, and communicates with an external apparatus, such as the server 200, through the network 300 (or directly) by wireless/wires. For example, the information processing apparatus 100 can transmit the transmission data, and receive the recommendation information transmitted from the server 200, by providing the communications section 102.

Further, for example, the communications section 102 is controlled by communications from the control section 104. Here, for example, while a communications antenna and RF circuit, a LAN terminal and transmission/reception circuit and the like are included as the communications section 102, the configuration of the communications section 102 is not limited to this. For example, the communications section 102 can be configured corresponding to an arbitrary standard that can perform communications, such as a USB terminal and transmission/reception circuit, or can be configured corresponding to the network 300.

The control section 104 is configured by an MPU, for example, and fulfills the role of controlling the entire information processing apparatus 100. Further, the control section 104 displays various setting screens such as shown in FIGS. 2 and 3, for example, on the display screen, and records setting information, based on an operation symbol corresponding to a user operation transmitted from the operation section (not shown), in the storage section (not shown).

Further, for example, the control section 104 includes a data generation section 110, an encryption processing section 112, and a transmission processing section 114 (apparatus side transmission processing section), and fulfills the role of initiatively performing the process (1) (data generation process) and the process (2) (transmission process) related to the information processing method in the information processing apparatus according to the present embodiment.

The data generation section 110 fulfills the role of initiatively performing the process of (1) above (data generation process). Here, for example, while the data of the structure shown in FIG. 4 is included as the transmission data generated by the data generation section 110, the transmission data created by the data generation section is not limited to the example shown in FIG. 4.

The encryption processing section 112 encrypts the generated transmission data, by the method of encryption shown by the encryption method information included in the transmission data, which is generated by the data generation section 110. For example, in the case where the transmission data of the structure shown in FIG. 4 is generated, the encryption processing section 112 encrypts parts A-C of FIG. 4.

The transmission processing section 114 fulfills the role of initiatively performing the process of (2) above (transmission process), and transmits the transmission data generated by the data generation section 110 (in the example shown in FIG. 7, the transmission data encrypted in the encryption processing section 112) to the server.

The control section 104 initiatively performs processes related to the information processing method in the information processing apparatus according to the present embodiment, by including, for example, the data generation section 110, the encryption processing section 112 and the transmission processing section 114.

The information processing apparatus 100, by the configuration shown in FIG. 7, for example, performs the processes of the process (1) (data generation process) and the process (2) (transmission process) related to the information processing method in the information processing apparatus according to the present embodiment. Therefore, the information processing apparatus 100 may realize the information processing system that may realize recommendations better reflecting the user's intentions, by having the configuration shown in FIG. 7, for example.

Note that the configuration of the information processing apparatus according to the present embodiment is not limited to the configuration shown in FIG. 7. For example, in the information processing system according to the present embodiment, the information processing apparatus according to the present embodiment may not be provided with the encryption processing section 112, when encryption of the transmission data is not performed. Further, the information processing apparatus according to the present embodiment may realize the encryption processing section 112, by a circuit that is separate from the control section 104.

While the above is described by including the information processing apparatus 100 as an element configuring the information processing system according to the present embodiment, the present embodiment is not limited to such a mode. For example, the present embodiment can be applied to communications equipment such as cellular phones and smart phones, image/music players (or image/music recording devices), game machines, electronic value cards, electronic tags and computers such as a PC (Personal Computer).

(Server According to the Present Embodiment)

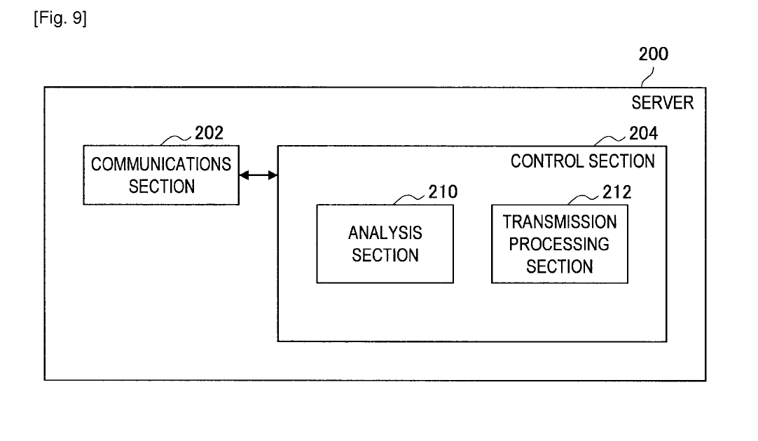

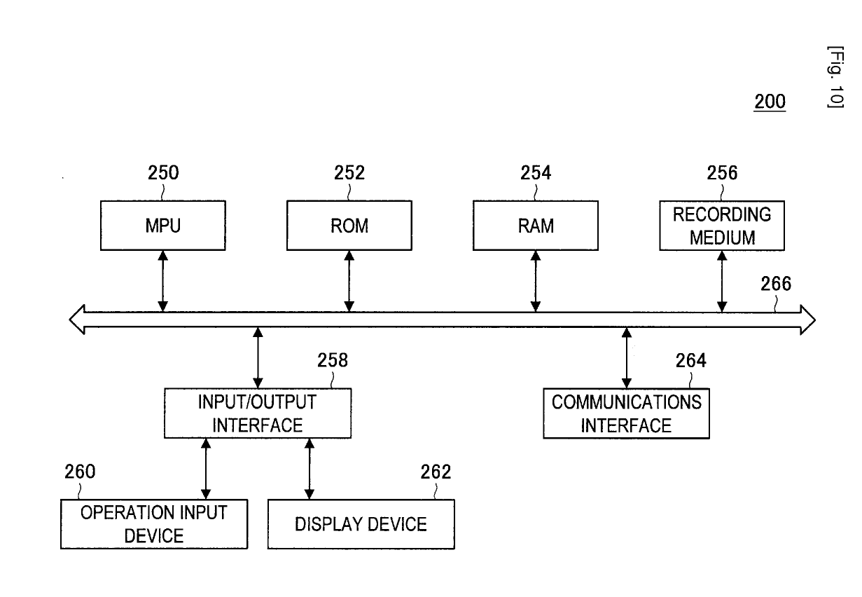

FIG. 9 is a block diagram showing an example of the configuration of the server 200 according to the present embodiment. For example, the server 200 includes a communications section 202 (server side communications section) and a control section 204.

Further, for example, the server 200 may include a ROM (not shown), a RAM (not shown), a storage section (not shown), an operation section that a user can operate as a manager of the server 200 (not shown), and a display section displaying various screens on a display screen (not shown). For example, the server 200 connects between each of the above components by a bus as a transmission line of data.

Here, the ROM (not shown) stores data for controlling such things as programs and calculation parameters used by the control section 204. The RAM (not shown) temporarily stores such things as programs realized by the control section 104.

The storage section (not shown) is a storage section provided by the server 200, and stores, for example, various data such as the data received from an external apparatus, and applications. For example, in the case where the server 200 is a server 200 according to the first embodiment shown in FIG. 1, and also in the case where the server 200 is a server 200A (an example of a first server) configuring the server group according to the second embodiment shown in FIG. 5, the transmission data transmitted from the information processing apparatus, for example, is stored in the storage section (not shown). Further, for example, in the case where the server 200 is a server 200B (an example of a second server) configuring the server group according to the second embodiment shown in FIG. 5, a table provided to each user, for example, is stored in the storage section (not shown). Here, for example, a magnetic recording medium, such as a hard disk, and non-volatile memory, such as a flash memory, are included as the storage section (not shown). Further, the storage section (not shown) may be detachable from the server 200.

The server 200, by the configuration shown in FIG. 10, for example, performs the processes related to the information processing method in the server according to the present embodiment (for example, a process in the server according to the first embodiment and a process in the server according to the second embodiment). It is needless to say that the hardware configuration of the server 200 according to the present embodiment is not limited to the configuration shown in FIG. 10.

Referring again to FIG. 9, an example of the configuration of the server 200 is described. The communications section 202 is a communications section provided by the server 200, and communicates with an external apparatus, such as an information processing apparatus, through the network 300 (or directly) by wireless/wires. Further, the communications section 202 is controlled by communications from the control section 204, for example. For example, the server 200 can perform reception of the transmission data, and the anonymous information and log data, and can perform transmission of related information relating to a user, by providing the communications section 202.

Here, for example, while the communications antenna and RF circuit and the LAN terminal and transmission/reception circuit are included as the communications section 202, the communications section 202 is not limited to the above. For example, the communications section 202 can adopt a configuration corresponding to an arbitrary standard that can communicate, such as a USB terminal and transmission/reception circuit, and a configuration corresponding to the network 300.

The control section 204 is configured by an MPU, for example, and fulfills the role of controlling the entire server 200. Further, for example, the control section 204 includes an analysis section 210 and a transmission processing section 212 (server side transmission processing section), and fulfills the role of initiatively performing the processes related to the information processing method in the server according to the present embodiment.

The analysis section 210 analyzes the transmission data including the anonymous information and the log data.

Here, in the case where the server 200 is the server 200 according to the first embodiment shown in FIG. 1, for example, the analysis section 210 initiatively performs the process of (I) above (analysis process). Further, in the case where the server 200 is the server 200 according to the second embodiment, for example, the analysis section 210 manages the log data for the anonymity of each user, based on the anonymous information (corresponding to the function of the server 200B shown in FIG. 5, for example). Note that in the case where the server 200 is the server 200 according to the second embodiment, for example, the analysis section 210 may initiatively perform the process of (I) above (analysis process) (corresponding to an example of a function possessed by the server 200A shown in FIG. 5, for example).

The transmission processing section 212 transmits, in the transmission section 202, related information, which relates to the user for whom the anonymous information is shown, to an external apparatus.

Here, in the case where the server 200 is the server 200 according to the first embodiment shown in FIG. 1, for example, the transmission processing section 212 initiatively performs the process of (II) above (transmission process). Further, in the case where the server 200 is the server 200 according to the second embodiment, for example, the transmission processing section 212 transmits log data corresponding to a transmission request received by the transmission section 202, as related information, to the external apparatus that transmitted the transmission request (corresponding to the function of the server 200B shown in FIG. 5, for example). Note that in the case where the server 200 is the server 200 according to the second embodiment, for example, the transmission processing section 212 may initiatively perform the process of (II) above (transmission process) (corresponding to an example of the function possessed by the server 200A shown in FIG. 5, for example).

The control section, by providing the analysis section 210 and the transmission section 212, for example, initiatively performs the processes related to the information processing method in the server according to the present embodiment.

The server 200, by the configuration shown in FIG. 9, for example, performs the processes (for example, the process in the server according to the first embodiment and the process in the server according to the second embodiment) related to the information processing method in the server according to the present embodiment. Therefore, the server 200 may realize the information processing system, which may realize recommendations reflecting the user's intentions, by the server having the configuration shown in FIG. 9, for example.

While the above describes the server 200 included as an element configuring the information processing system according to the present embodiment, the present embodiment is not limited to such a mode. For example, the present embodiment can be applied to a variety of equipment, such as a computer of a server, PC, or the like.

(A Program According to the Present Embodiment)

(A Program Related to the Information Processing Apparatus According to the Present Embodiment)

An information processing system may be realized, which may realize recommendations better reflecting the user's intentions, by a program for causing a computer to function as the information processing apparatus according to the present embodiment (for example, a program that may realize the processes related to the information processing method in the information processing apparatus according to the present embodiment, such as the process of (1) above (data generation process), and the process of (2) above (transmission process)).

(A Program Related to the Server According to the Present Embodiment)

An information processing system may be realized, which may realize recommendations better reflecting the user's intentions, by a program for causing a computer to function as the server according to the present embodiment (for example, a program that may realize the processes related to the information processing method in the server according to the present embodiment, such as the process in the server according to the first embodiment, and the process in the server according to the second embodiment).

It should be understood by those skilled in the art that various modifications, combinations, sub-combinations and alterations may occur depending on design requirements and other factors insofar as they are within the scope of the appended claims or the equivalents thereof.

For example, the information processing apparatus according to the present embodiment can be individually provided with the data generation section 100, the encryption processing section 112 and the transmission processing section 114 shown in FIG. 7 (for example, each section is realized by an individual processing circuit). Further, the information processing apparatus according to the present embodiment can be separately provided with the analysis section 210 and the transmission section 212 shown in FIG. 9 (for example, each section is realized by an individual processing circuit).

Further, for example, while the above shows a program for causing a computer to function as the information processing apparatus and each of the servers according to the present embodiment, the present embodiment can also be presented by a combined recording medium that stores each of the above programs.

The configuration described above shows an example of the present embodiment and justifiably belongs to the technical scope of the present disclosure.

Additionally, the present technology may also be configured as below.

(1)

A server including:

a control section to control generation of recommendation information based on log data from an information processing apparatus that communicates with the server over a network, wherein the log data includes data related to behavior of a user and combination data indicating at least one of a keyword or category selected by the user.

(2)

The server according to (1),

wherein the log data includes at least one of data related to offline behavior of the user and data related to online behavior of the user.

(3)

The server according to (1),

wherein the log data includes anonymous data for the user.

(4)

The server according to (3),

wherein the anonymous data includes account information related to a system providing a service.

(5)

The server according to (1),

wherein the control section controls generation of the recommendation information based on analysis of the log data.

(6)

The server according to (1),

wherein the recommendation information includes at least one of coupon data or information on at least one of an event, product or service.

(7)

The server according to (1),

wherein the log data includes setting information indicating a portion of the log data that the server can use to generate the recommendation information by transmitting at least some of the portion of the log data to another server performing a process related to provision of a service of a system indicated by the anonymous data.

(8)

The server according to (7),

wherein the service of a system includes a service of at least one of a social networking service or an online purchasing, ranking or reviewing service.

(9)

The server according to (1),

wherein the control section controls transmission of the recommendation information to another user having an account with a system providing a service indicated by the anonymous data based on a result of analysis of the log data of the user and log data of the another user communicated to the server.

(10)

The server according to (1),

wherein the log data includes information indicating use frequency and the recommendation information includes premium coupon information based on the use frequency.

(11)

The server according to (1),

wherein an item corresponding to a log is included in the log data communicated to the server based on whether the item is selected by the user for upload.

(12)

The server according to (1),

wherein the log data includes data indicating whether use in the server of data in the log data is permitted.

(13)

The server according to (1),

wherein the log data includes data indicating whether transmission to an external apparatus of data in the log data is permitted.

(14)

The server according to (1),

wherein the log data is determined based on at least one of predetermined setting information or setting information set based on a user operation.

(15)

The server according to (1),

wherein the log data includes log data from a system that provides a service and with which the user has an account.

(16)

The server according to (1),

wherein the log data includes at least one of account information, transportation information or sensor information corresponding to the user.

(17)

An information processing method including:

controlling, by a processor, generating of recommendation information based on log data from an information processing apparatus that communicates with the server over a network, wherein the log data includes data related to behavior of a user and combination data indicating at least one of a keyword or category selected by the user.

(18)

A non-transitory recording medium recorded with a program executable by a computer, the program including:

controlling generating of recommendation information based on log data from an information processing apparatus that communicates with the server over a network, wherein the log data includes data related to behavior of a user and combination data indicating at least one of a keyword or category selected by the user.

(19)

An information processing apparatus including:

a control unit to control generation of log data, wherein the log data includes data related to behavior of a user and combination data indicating at least one of a keyword or category selected by the user, and to control transmission of the log data over a network to a server for receiving recommendation information generated from the log data by the server.

(20)

An information processing apparatus comprising:

a control unit to control display of a display screen as a setting screen for selection of log data, wherein the log data includes data related to behavior of a user and combination data indicating at least one of a keyword or category selected by the user, wherein the control unit controls generation of transmission data based on setting information set in accordance with user operation of the setting screen.

(21)

An information processing apparatus including:

a communications section which communicates with a server generating recommendation information;

a data generation section which generates transmission data including a plurality of log data for generating the recommendation information in the server, anonymous information for managing a user associated with a service, and combination information showing a combination of the log data that can be used by the user; and

a transmission processing section which transmits the generated transmission data to the server.

(22)

The information processing apparatus according to (21), further including: an encryption processing section which encrypts the generated transmission data by a method of encryption shown by encryption method information;

wherein the data generation section generates transmission data further including the encryption method information showing the method of encryption of the transmission data; and

wherein the transmission processing section transmits the encrypted transmission data to the server.

(23)

The information processing apparatus according to (21) or (22),

wherein information showing an accumulated recording frequency of a log is included in the log data.

(24)

The information processing apparatus according to any one of (21) to (23),

wherein the communications section receives the recommendation information generated in the server.

(25)

A server including:

a communications section which communicates with an external apparatus;

an analysis section which analyzes transmission data including anonymous information, for managing a user associated with a service, and log data; and

a transmission processing section which transmits, in the communications section, related information, which relates to the user for whom anonymous information is shown, to the external apparatus.

(26)

The server according to (25),

wherein the communications data includes a plurality of log data and combination information showing a combination of the log data that can be used;

wherein the analysis section generates recommendation information as the related information, by analyzing the log data corresponding to the combination data, from within the entire log data included in the transmission data; and

wherein the transmission processing section transmits the generated recommendation information to the external apparatus that transmitted the transmission data.

(27)

The server according to (25),

wherein the analysis section manages the log data for the anonymity of each user, based on the anonymous information; and

wherein the transmission section transmits the log data corresponding to a transmission request received by the communications section, as the related information, to the external apparatus that transmitted the transmission request.

(28)

The server according to (27),

wherein the transmission data is data transmitted from another server that processes by receiving data including the plurality of the log data transmitted from the information processing apparatus.

(29)

An information processing system having:

an information processing apparatus; and

a server which communicates with the information processing apparatus;

wherein the information processing apparatus comprises:

an apparatus side communications section which communicates with the server;

a data generation section which generates transmission data including a plurality of log data, anonymous information for managing a user associated with a service, and combination information showing a combination of the log data that can be used by the user;

an apparatus side transmission processing section which transmits the generated transmission data to the server; and

wherein the server comprises:

a server side communications section which communicates with the information processing apparatus;

an analysis section which generates recommendation information by analyzing the log data corresponding to the combination data, from within the entire log data included in the transmission data; and

a server side transmission processing section which transmits, in the communications section, the generated recommendation information to the information processing apparatus.

(30)

An information processing system having:

an information processing apparatus; and

a server which communicates with the information processing apparatus;

wherein the information processing section comprises:

a communications section which communicates with the server;

a data generation section which generates transmission data including a plurality of log data, anonymous information for managing a user associated with a service, and combination information showing a combination of the log data that can be used by the user;

a transmission processing section which transmits the generated transmission data to the server;

wherein the server manages the log data corresponding to the combination data, from within the entire log data included in the transmission data that is transmitted from the information processing apparatus, for the anonymity of each user, based on the anonymous information included in the transmission data; and

wherein the server transmits the log data corresponding to a transmission request transmitted from the external apparatus, as related information, which relates to the user for whom anonymous information is shown, to the external server that transmitted the transmission request.

(31)

The information processing system according to (30),

wherein the server is a server group which has a first server communicating with the information processing apparatus, and a second server communicating with the first server;

wherein the first server transmits the anonymous information included in the transmission data transmitted from the information processing apparatus, and the log data corresponding to the combination data, from within the entire log data included in the transmission data transmitted from the information processing apparatus, to the second server; and

wherein the second server manages the log data for each user, based on the anonymous information, and transmits the log data corresponding to the transmission request to the external apparatus that transmitted the transmission request.

(32)

An information processing method including:

generating transmission data including a plurality of log data for receiving recommendation information, anonymous information for managing a user associated with a service, and combination information showing a combination of the log data that can be used by the user; and

transmitting the generated transmission data to a server generating the recommendation information.

(33)

An information processing method including:

receiving transmission data including a plurality of log data, anonymous information for managing a user associated with a service, and combination information showing a combination of the log data that can be used by the user;

generating recommendation information by analyzing the log data corresponding to the combination data, from within the entire log data included in the transmission data; and

transmitting the generated transmission data to an information processing apparatus that transmitted the transmission data.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100, 100A, 100B information processing apparatus
102, 202 communications section
104, 204 control section
110 data generation section
112 encryption processing section
114, 212 transmission processing section
200, 200A, 200B server
210 analysis section

1. A server comprising:
a control section to control generation of recommendation information based on log data from an information processing apparatus that communicates with the server over a network, wherein the log data includes data related to behavior of a user and combination data indicating at least one of a keyword or category selected by the user.

2. The server of claim 1, wherein the log data includes at least one of data related to offline behavior of the user or data related to online behavior of the user.

3. The server of claim 1, wherein the log data includes anonymous data for the user.

4. The server of claim 3, wherein the anonymous data includes account information related to a system providing a service.

5. The server of claim 1, wherein the control section controls generation of the recommendation information based on analysis of the log data.

6. The server of claim 1, wherein the recommendation information includes at least one of coupon data or information on at least one of an event, product or service.

7. The server of claim 1, wherein the log data includes setting information indicating a portion of the log data that the server can use to generate the recommendation information by transmitting at least some of the portion of the log data to another server performing a process related to provision of a service of a system indicated by the anonymous data.

8. The server of claim 7, wherein the service of a system includes a service of at least one of a social networking service or an online purchasing, ranking or reviewing service.

9. The server of claim 1, wherein the control section controls transmission of the recommendation information to another user having an account with a system providing a service indicated by the anonymous data based on a result of analysis of the log data of the user and log data of the another user communicated to the server.

10. The server of claim 1, wherein the log data includes information indicating use frequency and the recommendation information includes premium coupon information based on the use frequency.

11. The server of claim 1, wherein an item corresponding to a log is included in the log data communicated to the server based on whether the item is selected by the user for upload.

12. The server of claim 1, wherein the log data includes data indicating whether use in the server of data in the log data is permitted.

13. The server of claim 1, wherein the log data includes data indicating whether transmission to an external apparatus of data in the log data is permitted.

14. The server of claim 1, wherein the log data is determined based on at least one of predetermined setting information or setting information set based on a user operation.

15. The server of claim 1, wherein the log data includes log data from a system that provides a service and with which the user has an account.

16. The server of claim 1, wherein the log data includes at least one of account information, transportation information or sensor information corresponding to the user.

17. An information processing method comprising:
controlling, by a processor, generating of recommendation information based on log data from an information processing apparatus that communicates with the server over a network, wherein the log data includes data related to behavior of a user and combination data indicating at least one of a keyword or category selected by the user.

18. A non-transitory recording medium recorded with a program executable by a computer, the program comprising:
controlling generating of recommendation information based on log data from an information processing apparatus that communicates with the server over a network, wherein the log data includes data related to behavior of a user and combination data indicating at least one of a keyword or category selected by the user.

19. An information processing apparatus comprising:
a control unit to control generation of log data, wherein the log data includes data related to behavior of a user and combination data indicating at least one of a keyword or category selected by the user, and to control transmission of the log data over a network to a server for receiving recommendation information generated from the log data by the server.

20. An information processing apparatus comprising:
a control unit to control display of a display screen as a setting screen for selection of log data, wherein the log data includes data related to behavior of a user and combination data indicating at least one of a keyword or category selected by the user, wherein the control unit controls generation of transmission data based on setting information set in accordance with user operation of the setting screen.
